(19) United States
(12) Patent Application Publication
(10) Pub. No.: US 2013/0240075 A1
(43) Pub. Date: Sep. 19, 2013

(54) PIPE ASSEMBLY FOR DIFFERENTIAL PRESSURE SENSOR

(71) Applicants: HONG FU JIN PRECISION INDUSTRY (SHENZHEN) CO.,, Shenzhen (CN); HON HAI PRECISION INDUSTRY CO., LTD., New Taipei (TW)

(72) Inventor: XU YANG, Shenzhen (CN)

(73) Assignees: HON HAI PRECISION INDUSTRY CO., LTD., New Taipei (TW); HONG FU JIN PRECISION INDUSTRY (ShenZhen) CO., LTD., Shenzhen (CN)

(21) Appl. No.: 13/688,428

(22) Filed: Nov. 29, 2012

(30) Foreign Application Priority Data
Mar. 15, 2012 (CN) 201210067657.0

(51) Int. Cl. F16L 3/00

(52) U.S. Cl. CPC F16L 3/00
USPC 138/106

(57) ABSTRACT

A pipe assembly includes an enclosure and two pipes. The enclosure includes a bottom panel and a first side panel. The first side panel includes a side panel body, a first securing tab, and a second securing tab extending from the side panel body. The first securing tab and the second securing tab are located on opposite sides of the side panel body. The first securing tab defines a first securing hole. The second securing tab defines a second securing hole. Two first elastic gaskets are mounted in the first and second securing holes. Each elastic gasket defines a first through opening. Each pipe includes a pipe body and an input portion. The pipe bodies extend through the first through opening of each elastic gasket, thereby being secured to the enclosure. The two input portions are substantially parallel to each other and substantially parallel to the side panel body.

### BACKGROUND

1. Technical Field

The disclosure generally relates to pipe assemblies, especially, to a pipe assembly for a differential pressure sensor.

2. Description of Related Art

A cloud server needs to sense air pressure between opposite sides of the filtering meshwork, via a differential pressure sensor, for controlling pressure difference between the opposite sides of the filtering meshwork within a certain range. The differential pressure sensor includes two pipes located on opposite sides of the filtering meshwork to receive air. The two pipes are not secured slidably, which may effect precision of the sensed values of the differential pressure sensor.

Thus, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the several views.

FIG. 1 is an exploded, isometric view of an embodiment of elastic gaskets and the enclosure of a pipe assembly.

FIG. 2 is a partial, enlarged view of FIG. 1.

FIG. 3 is an isometric view of an elastic gasket of FIG. 1.

FIG. 4 is an assembled view of FIG. 1.

FIG. 5 is an assembled view of an embodiment of a pipe assembly.

FIG. 6 is a partial, enlarged view of FIG. 5.

FIG. 7 is another assembled view of an embodiment of a pipe assembly.

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean at least one.

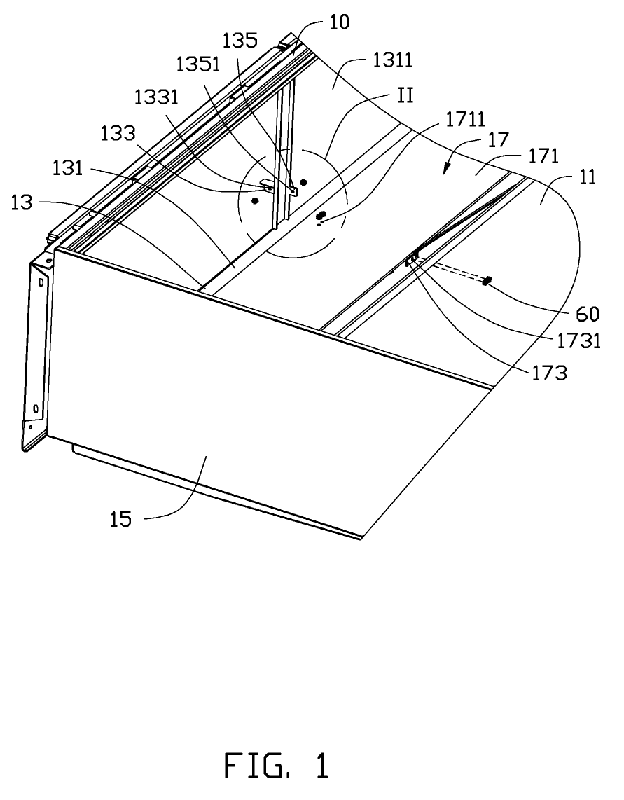

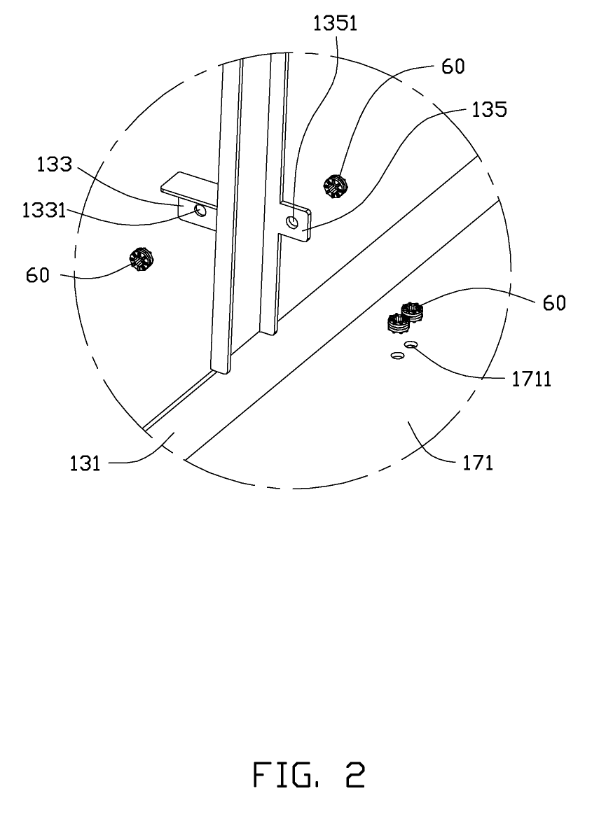

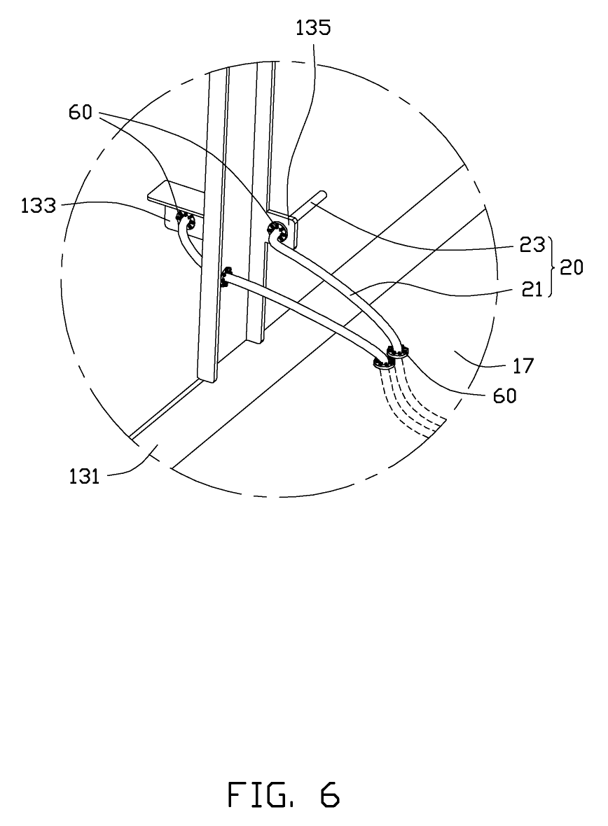

FIGS. 1 and 2 show one embodiment of a pipe assembly for a differential pressure sensor. The pipe assembly includes an enclosure 10 and two pipes 20 (shown in FIG. 6). The two pipes 20 are used for connecting to a differential pressure sensor (not shown).

The enclosure 10 includes a bottom panel 11, a first side panel 13, two second side panels 15, and a plane panel 17. The two second side panels 15 are substantially parallel to each other and substantially perpendicular to the bottom panel 11. The first side panel 13 is substantially perpendicular to the second side panel 15. The plane panel 17 is connected between the two second side panels 15 and connected to the first side panel 13.

The first side panel 13 includes a side panel body 131, a first securing tab 133 extending from the side panel body 131, and a second securing tab 135 extending from the side panel body 131. The side panel body 131 perpendicularly extends from the bottom panel 11. The first securing tab 133 defines a first securing hole 1331. The second securing tab 135 defines a second securing hole 1351. The side panel body 131 defines a mounting opening 1311. The mounting opening 1311 is used for receiving a filtering meshwork (not shown). The second securing tab 135 and the first securing tab 133 are located on opposite sides of the side panel body 131.

The plane panel 17 includes a plane panel body 171, that is substantially parallel to the bottom panel 11, and a mounting tab 173 perpendicularly extending from the plane panel body 171. The mounting tab 173 defines two mounting holes 1731. The plane panel body 171 defines two through holes 1711. The plane panel body 171 is connected to the side panel body 131 of the first side panel 13.

Each pipe 20 includes a pipe body 21 and an input portion 23 connected to the pipe body 21. The pipe body 21 extends through each of the first securing hole 1331, the second securing hole 1351, the mounting hole 1731, and the through hole 1711 via an elastic gasket 60.

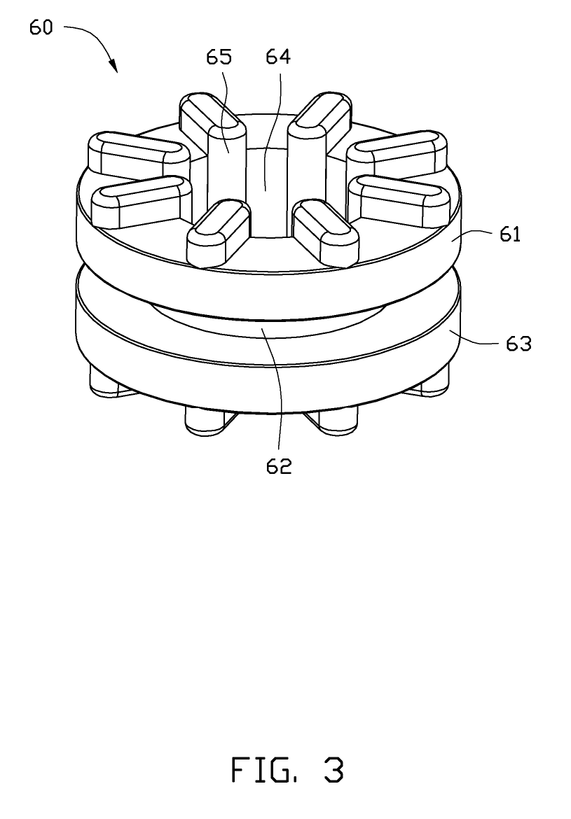

FIG. 3 shows that the elastic gasket 60 is H-shaped. The elastic gasket 60 is made of rubber. The elastic gasket 60 includes a first end portion 61, a neck portion 62 extending from the first end portion 61, and a second end portion 63 extending from the neck portion 62. A through opening 64 extends through the first end portion 61, the neck portion 62, and the second end portion 63. The elastic gasket 60 further includes a plurality of protrusions 65 extending from the inner surface of the through opening 64.

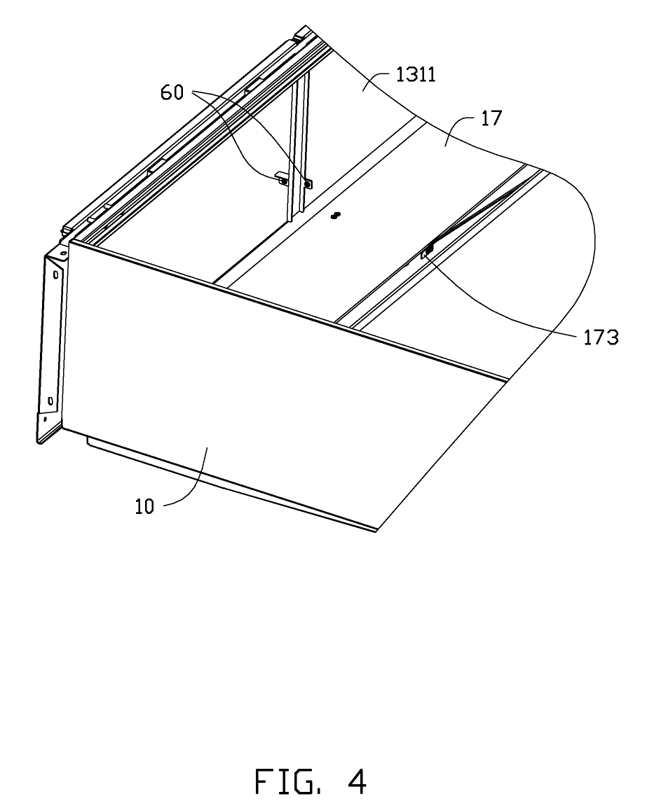

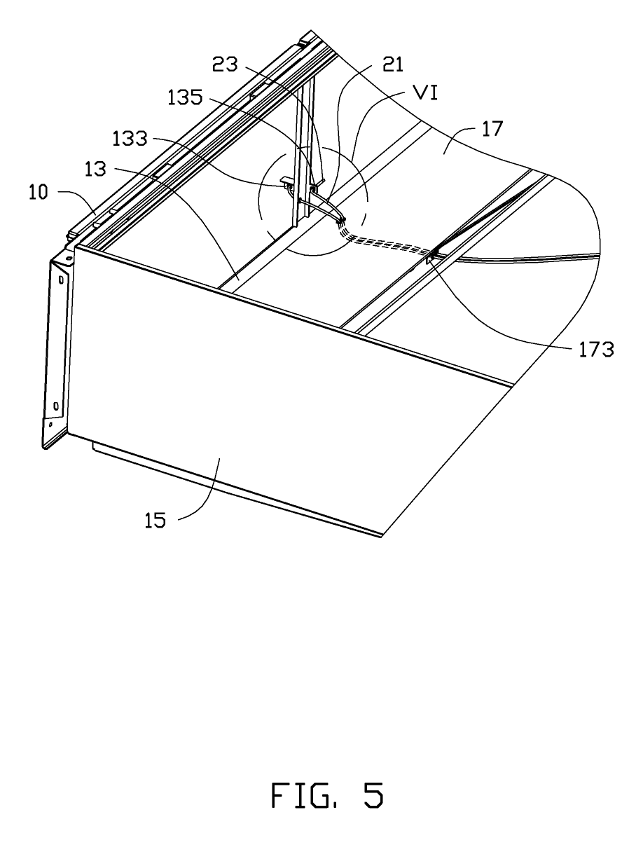

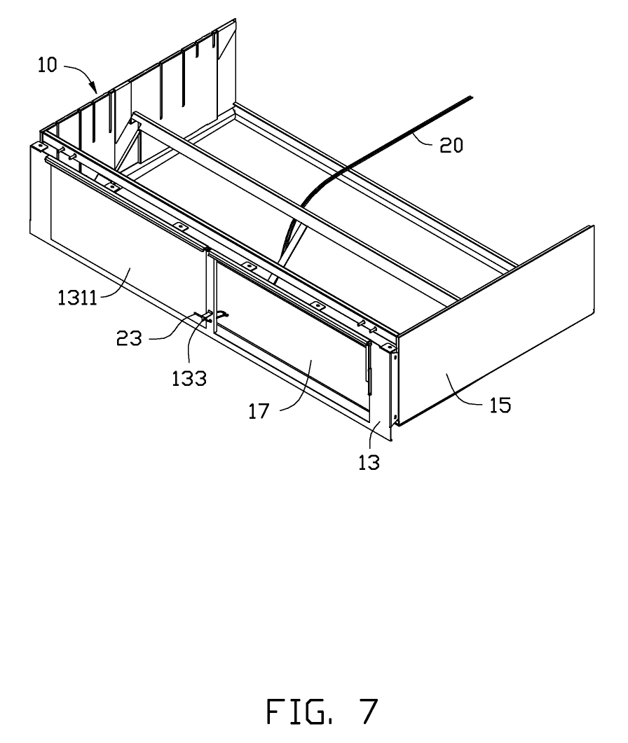

FIGS. 4 to 7 show that in assembly, the elastic gaskets 60 are mounted in the first securing holes 1331, the second securing holes 1351, the mounting holes 1731, and the through holes 1711. The first end portion 61 and the second end portion 63 of each elastic gasket 60 are located on opposite sides of theses holes. The pipes 20 extend through the through openings 64 of the elastic gasket 60 to enable the input portions 23, of the two pipes 20, to be located on opposite sides of the filtering meshwork. At this time, the two input portions 23 are substantially parallel to the side panel body 131 and the bottom panel 11. The protrusions of the elastic gaskets 60 resiliently resist the pipe bodies 21 of the two pipes 20, thereby securing the two pipes 20 to the enclosure 10.

It is to be understood, however, that even though numerous characteristics and advantages have been set forth in the foregoing description of embodiments, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. A pipe assembly, comprising:
an enclosure, the enclosure comprises a bottom panel and a first side panel extending from the bottom panel; the first side panel comprises a side panel body, a first securing tab extending from the side panel body, and a second securing tab extending from the side panel body; the first securing tab and the second securing tab are located on opposite sides of the side panel body; the first securing tab defines a first securing hole; the second securing tab defines a second securing hole; two first elastic gaskets are mounted in the first securing hole and the second securing hole; and each of the two first elastic gaskets defines a first through opening; and
two pipes; each of the two pipes comprises a pipe body and an input portion extending from the pipe body; the pipe body of each of the two pipes extends through the first through opening of each elastic gasket and is secured to the enclosure; and the two input portions of the two pipes are substantially parallel to each other and substantially parallel to the side panel body.

2. The pipe assembly of claim 1, wherein each of the two first elastic gaskets comprises a first end portion, a second end portion, and a neck portion connected between the first end portion and the second end portion; the first through opening extends through the first end portion, the neck portion, and the second end portion; the two neck portions are located in the first securing hole and the second securing hole; the first end portion and the second end portion, of the elastic gasket mounted in the first securing hole, are located on opposite sides of the first securing tab; and the first end portion and the second end portion, of the elastic gasket mounted in the second securing hole, are located on opposite sides of the second securing tab.

3. The pipe assembly of claim 2, wherein the two first elastic gaskets are H-shaped.

4. The pipe assembly of claim 2, wherein each of the two first elastic gaskets further comprises a plurality of protrusions extending from an inner surface of the first through opening, and the plurality of protrusions resiliently resist the pipe body.

5. The pipe assembly of claim 1, wherein the enclosure further comprises two second side panels, that are substantially parallel to each other, and a plane panel, connected between the two second side panels; the two second side panels extend from the bottom panel and are substantially perpendicular to the bottom panel; the plane panel comprises a plane panel body that is substantially parallel to the bottom panel; the plane panel body defines two through holes corresponding to the pipe bodies of the two pipes; a second elastic gasket is mounted in each of the two through holes; the second elastic gasket defines a second through opening; and the pipe bodies of the two pipes extend through the second through openings of the two second elastic gaskets.

6. The pipe assembly of claim 5, wherein the plane panel further comprises a mounting tab extending from the plane panel body; the mounting tab defines two mounting holes; a third elastic gasket is mounted in each of the two mounting holes; the third elastic gasket defines a third through opening; and the pipe bodies of the two pipes extend through the third through openings of the two third elastic gaskets.

7. The pipe assembly of claim 6, wherein the mounting tab is substantially perpendicular to the plane panel body.

8. The pipe assembly of claim 5, wherein the plane panel body is connected to the side panel body.

9. The pipe assembly of claim 1, wherein the side panel body is substantially perpendicular to the bottom panel.

10. The pipe assembly of claim 1, wherein the two input portions are substantially parallel to the bottom panel.

11. A pipe assembly, comprising:
an enclosure, the enclosure comprises a bottom panel and a first side panel extending from the bottom panel; the first side panel comprises a side panel body, a first securing tab extending from the side panel body along a first direction, and a second securing tab extending from the side panel body along a second direction substantially opposite to the first direction; the first securing tab defines a first securing hole; the second securing tab defines a second securing hole; two first elastic gaskets are mounted in the first securing hole and the second securing hole; and each of the two first elastic gaskets defines a first through opening; and
two pipes; each of the two pipes comprises a pipe body and an input portion extending from the pipe body; the pipe body of each of the two pipes extend through the first through opening of each elastic gasket to enable the two input portions of the two pipes to extend in the same direction and to be substantially parallel to each other.

12. The pipe assembly of claim 11, wherein each of the two first elastic gaskets comprises a first end portion, a second end portion, and a neck portion connected between the first end portion and the second end portion; the first through opening extends through the first end portion, the neck portion, and the second end portion; the two neck portions are located in the first securing hole and the second securing hole; the first end portion and the second end portion, of the elastic gasket mounted in the first securing hole, are located on opposite sides of the first securing tab; and the first end portion and the second end portion, of the elastic gasket mounted in the second securing hole, are located on opposite sides of the second securing tab.

13. The pipe assembly of claim 12, wherein the two first elastic gaskets are H-shaped.

14. The pipe assembly of claim 12, wherein each of the two first elastic gaskets further comprises a plurality of protrusions extending from an inner surface of the first through opening, and the plurality of protrusions resiliently resist the pipe body.

15. The pipe assembly of claim 11, wherein the enclosure further comprises two second side panels, that are substantially parallel to each other, and a plane panel, connected between the two second side panels; the two second side panels extend from the bottom panel and are substantially perpendicular to the bottom panel; the plane panel comprises a plane panel body that is substantially parallel to the bottom panel; the plane panel body defines two through holes corresponding to the pipe bodies of the two pipes; a second elastic gasket is mounted in each of the two through holes; the second elastic gasket defines a second through opening; and the pipe bodies of the two pipes extend through the second through openings of the two second elastic gaskets.

16. The pipe assembly of claim 15, wherein the plane panel further comprises a mounting tab extending from the plane panel body; the mounting tab defines two mounting holes; a third elastic gasket is mounted in each of the two mounting holes; the third elastic gasket defines a third through opening; and the two pipe bodies of the two pipes extend through the third through openings of the two third elastic gaskets.

17. The pipe assembly of claim 16, wherein the mounting tab is substantially perpendicular to the plane panel body.

18. The pipe assembly of claim 15, wherein the plane panel body is connected to the side panel body.

19. The pipe assembly of claim 11, wherein the side panel body is substantially perpendicular to the bottom panel.

20. The pipe assembly of claim 11, wherein the two input portions are substantially parallel to the bottom panel.
